(19) United States
(12) Patent Application Publication
(10) Pub. No.: US 2025/0193209 A1
(43) Pub. Date: Jun. 12, 2025

(54) USING SENSORS TO DETECT POTENTIAL SECURITY RISKS

(71) Applicant: INTERNATIONAL BUSINESS MACHINES CORPORATION, ARMONK, NY (US)

(72) Inventors: ANDREW C. M. HICKS, HIGHLAND, NY (US); JOHN S. WERNER, FISHKILL, NY (US); RAFAELA FROTA, POUGHKEEPSIE, NY (US); FAEZEH GHOLAMI, RIDGEWOOD, NJ (US); CHRISTOPHER V DEROBERTIS, HOPEWELL JUNCTION, NY (US)

(21) Appl. No.: 18/531,996

(22) Filed: Dec. 7, 2023

(51) Int. Cl. H04L 9/40

(52) U.S. Cl. CPC H04L 63/14

(57) ABSTRACT

Methods, apparatus, and systems for using sensors to detect potential security risks include tracking, by a sensor, a component of a system, comparing sensor data from the sensor with a baseline measurement associated with the component, and flagging, based on detecting that the sensor data differs from the baseline measurement by a threshold amount, the sensor data as indicating a potential security risk.

### BACKGROUND

The present disclosure relates to methods and systems for using sensors to detect potential security risks.

### SUMMARY

Methods and systems for using sensors to detect potential security risks according to various embodiments are disclosed in this specification. In accordance with one aspect of the present disclosure, a method of using sensors to detect potential security risks may include tracking, by a sensor, a component of a system, comparing sensor data from the sensor with a baseline measurement associated with the component, and flagging, based on detecting that the sensor data differs from the baseline measurement by a threshold amount, the sensor data as indicating a potential security risk.

In accordance with another aspect of the present disclosure, using sensors to detect potential security risks may include a system including a sensor configured to monitor a component of a system, and a processor commutatively coupled to the sensor and configured to: track, via the sensor, the component of the system, compare sensor data from the sensor with a baseline measurement associated with the component, and flag, based on detecting that the sensor data differs from the baseline measurement by a threshold amount, the sensor data as indicating a potential security risk.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an example system configured for using sensors to detect potential security risks in accordance with embodiments of the present disclosure.

FIG. 2 shows a block diagram of an example system configured for using sensors to detect potential security risks in accordance with embodiments of the present disclosure.

FIG. 3 is a block diagram of an example computing environment configured for using sensors to detect potential security risks according to some embodiments of the present disclosure.

FIG. 4 is a flowchart of an example method for using sensors to detect potential security risks according to some embodiments of the present disclosure.

FIG. 5 is a flowchart of another example method for using sensors to detect potential security risks according to some embodiments of the present disclosure.

### DETAILED DESCRIPTION

Industrial control systems (ICS), such as supervisory control and data acquisition (SCADA) systems, are electronic control systems that may be used for industrial process control. Such control systems may include one or more, and sometimes many, different components, such as IoT (internet of things) devices. Often, SCADA systems are left unattended without user monitoring. Such systems may also be relatively old or out of date or may lack consistent upgrades. Sometimes, consumers or other personnel may be unable to access the components of the system or monitor what they are doing, except by the information they provide. Threat actors may be able to attack or exploit such industrial control systems, such as to gain access to other systems attached to the ICS. Accordingly, SCADA and other industrial control systems may become a target for threat actors. When a SCADA system is exploited or under attack, the monitoring measurements provided by the attacked system may be untrustworthy, thereby preventing someone from noticing that the system has become compromised. For example, a threat actor may access a SCADA system and change sensor measurements so that the system looks like it is behaving as expected to someone monitoring the system, even though the system is actually behaving irregularly. Embodiments of the present disclosure describes various methods and systems for adding sensors to such systems in order to monitor the system for potential security risks.

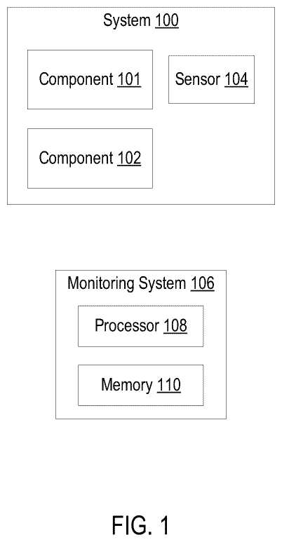

Exemplary methods, apparatus, and systems for using sensors to detect potential security risks in accordance with the present disclosure are described with reference to the accompanying drawings, beginning with FIG. 1. FIG. 1 sets forth a block diagram of an example system configured for using sensors to detect potential security risks in accordance with embodiments of the present disclosure. The example system of FIG. 1 includes a system 100 and a monitoring system 106. System 100 of FIG. 1 includes multiple components (such as component 101 and component 102) and a sensor 104. In one embodiment, the sensor 104 was added to the system 100 to monitor one or more components of the system 100. The monitoring system 106 of FIG. 1 includes a processor 108 and memory 110. The monitoring system may include one or more other components.

The example system of FIG. 1 is a SCADA system configured for controlling an industrial process. In another embodiment, the system 100 is another other type of industrial control system or computing system. In one embodiment, the system 100 may be a cluster of systems.

The example components of FIG. 1, such as component 101 and component 102, may be any component of an electronic control system or other computing system. For example, the component 101 may be an IoT device, such as a sensor, configured to monitor the flow rate of water within a hydroelectric dam. In another embodiment, component 101 may be a processor, fan, pump, valve, computer, modem, sensor, and the like. In one embodiment there are multiple of the same type of components within the system. The components may be configured to provide SCADA data.

The example sensor of FIG. 1 is configured to monitor one or more components of system 100 and provide sensor data. For example, sensor 104 may be a temperature sensor configured to monitor the temperature of one or more components of system 100 and provide sensor data in the form of temperature measurements. In another embodiment, where the component (such as component 101) is an IoT device or sensor), the sensor 104 is configured to monitor whatever the IoT device or component is monitoring. For example, in a system with an IoT device configured to monitor the flow rate of water, the sensor 104 may also be configured to monitor the flow rate of the water and provide sensor data in the form of flow rate measurements. In another example, the component 101 may be a pump and the sensor 104 may be configured to monitor information associated with the pump, such as pump activity, diagnostics, and the like. In another example, the component may be a fan, or a fan speed monitor, and the sensor may be configured to monitor the fan speed. The sensor 104 may be any type of sensor and may be configured to monitor any type of component. For example, the sensor 104 may be configured to monitor processor utilization, component temperature, water-cooling flow rates, vent activity, environmental conditions, system variables, and the like. The sensor 104 may be added to the system 100 as a means for monitoring the system for potential security risks. In one embodiment, multiple sensors may be added to system 100. The sensor data obtained from added sensors (such as sensor 104) may be stored within system 100 or may be sent to monitoring system 106 and stored in memory 110.

To detect a potential security risk or activity, a determination of whether or not the system is behaving irregularly is made by comparing sensor data obtained from the added sensors (such as sensor 104) with expected system data. In order to know what sensor measurements to expect during normal operation or functionality of the system, and thus to have something to compare the sensor data with to detect an anomaly, one or more baselines (or baseline measurements) may be established for various system functions or conditions. Such baselines may be established by system 100 and sent to monitoring system 106 for comparison with sensor data. In another embodiment, the baselines may be established by monitoring system 106, via one or more sensors added to system 100 (such as sensor 104). One or more baseline measurements may be established for each component of system 100, and may each take into account various system functions, environmental conditions, system workloads, and the like. The baselines depict how the system, and each of the included components, should behave (and what sensor measurements should be expected) during normal operation. Such baselines may be established for every different system function and in varying condition. Accordingly, for any given condition or system function, a particular baseline may be selected that provides expected sensor measurements for a normally behaving system. Such expected measurements may then be compared with the incoming sensor data (obtained in real-time from the one or more added sensors, such as sensor 104) to identify when the system behaving irregularly in order to detect when the system is experiencing a potential security threat or risk. Such a comparison may be made by the processor 108 of monitoring system 106, which is communicatively coupled to the sensor 104. In comparing the obtained sensor data with the expected baseline measurement, a potential security risk may be detected based on the sensor data differing from the expected baseline measurement by a threshold amount. The threshold amount may be dependent on the type of sensor, the component being measured, the type of system, the system functions, or conditions present, and the like. For example, in one embodiment the threshold amount must be equal to or greater than a 3% difference. In another example, the threshold amount may be some fixed value.

Once a security threat is recognized, further actions may be taken. For example, a notification may be automatically sent including the sensor data and an indication of a potential security risk. In other embodiments, the sensor data and the indication of a potential security risk may be stored in memory (such as in memory of the system 100 or memory 110 of the monitoring system 106). Other actions taken may include automated corrective actions, such as shutting down the system 100, modifying system settings, and the like.

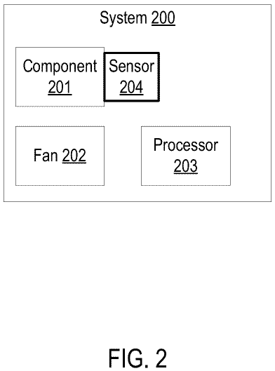

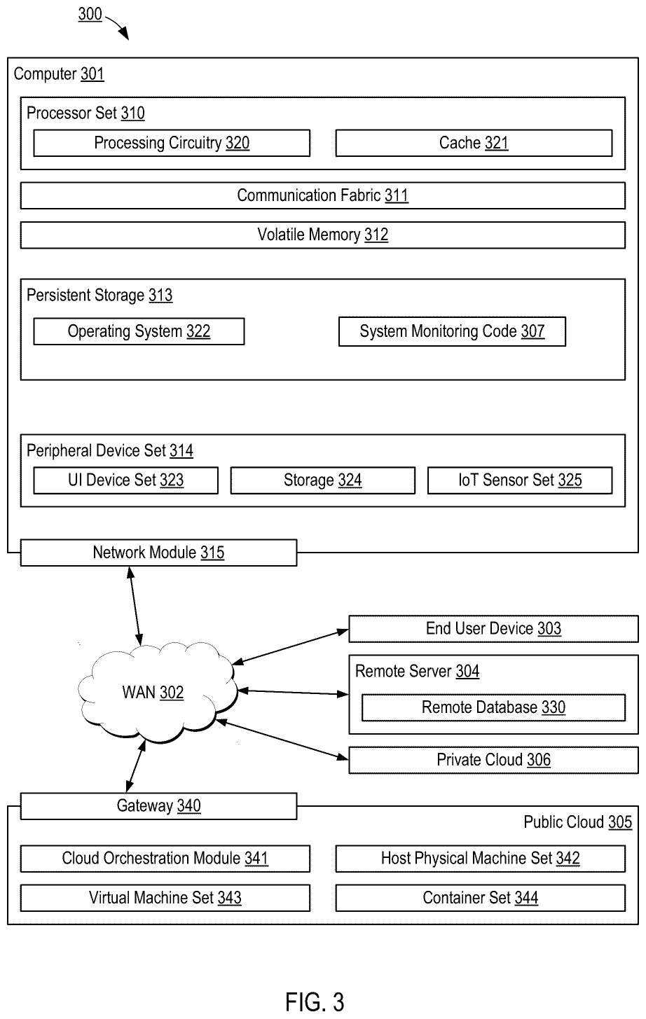

For further explanation, FIG. 2 sets forth a block diagram of another example system configured for using sensors to detect potential security risks in accordance with embodiments of the present disclosure. The example of FIG. 2 differs from FIG. 1 in that FIG. 2 has an added sensor 204 mounted directly to pre-existing component 201 of system 200. In the example of FIG. 2, component 201 is configured to monitor the fan speed of fan 202. In such an example, sensor 204 is also configured to monitor the fan speed of fan 202. In the example of the FIG. 2, sensor data obtained by sensor 204 is sent to processor 203 of system 200 for comparison to expected baseline measurements, rather than being sent to an external monitoring system. In such an example, the processor 203 of system 200 may be updated to include system monitoring code (see FIG. 3 for more information).

In one embodiment, according to an established baseline, an expected fan speed for fan 202, given a particular processor utilization, is 2300 RPM. However, in an embodiment where a threat actor has gained access to system 200, the system 200 may be reporting a fan speed measured by component 201 that is consistent with the expected fan speed, while the added sensor 204 is reporting a fan speed significantly higher than what is expected (such as 3700 RPM). In such an example, the difference between the sensor data and the expected measurement exceeds the threshold amount, and the sensor data may be flagged as indicating a potential security risk. Accordingly, a notification may be sent, or the sensor data and the indication may be stored within memory (either local to the system or external to the system).

For further explanation, FIG. 3 sets forth a block diagram of computing environment 300 configured for cooling optical interconnects using light in accordance with embodiments of the present disclosure. Computing environment 300 contains an example of an environment for the execution of at least some of the computer code involved in performing the inventive methods, such as system monitoring code 307. In addition to system monitoring code 307, computing environment 300 includes, for example, computer 301, wide area network (WAN) 302, end user device (EUD) 303, remote server 304, public cloud 305, and private cloud 306. In this example embodiment, computer 301 may be monitoring system 106 of FIG. 1, and includes processor set 310 (including processing circuitry 320 and cache 321), communication fabric 311, volatile memory 312, persistent storage 313 (including operating system 322 and system monitoring code 307, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344. In another embodiment, computer 301 may be system 100 of FIG. 1, where the sensor 104 provides the sensor data to the system.

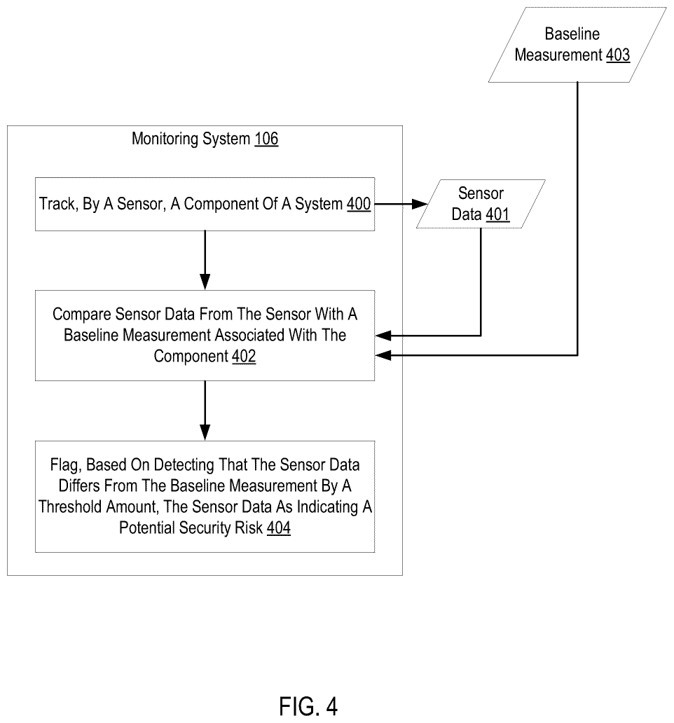

Computer 301 may take the form of a desktop computer, laptop computer, tablet computer, smart phone, wearable computer, smart watch, mainframe computer, quantum computer or any other form of computer or mobile device now known or to be developed in the future that is capable of running a program, accessing a network, or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 4. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in system monitoring code 307 in persistent storage 313.

Communication fabric 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in system monitoring code 307 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

For further explanation, FIG. 4 sets forth a flow chart illustrating an exemplary method of using sensors to detect potential security risks according to embodiments of the present disclosure. The method of FIG. 4 includes tracking 400, by a sensor, a component of a system. Tracking 400 a component of a system may be carried out by a monitoring system (such as monitoring system 106) via a sensor to obtain sensor data 401. Sensor data 401 may include sensor measurements associated with the one or more components being monitored by the sensor.

The method of FIG. 4 also includes comparing 402 sensor data from the sensor with a baseline measurement associated with the component. Comparing 402 sensor data from the sensor with a baseline measurement may be carried out by monitoring system 106 comparing, in real time, the incoming sensor data 401 from the sensor with a previously determined baseline measurement 403. The baseline measurement 403 include measurements of a same type as the measurements being obtained within the sensor data 401. The baseline measurement 403 includes expected measurements for a system or component under normal operation and in conditions consistent with the present conditions of the system or component being monitored by the sensor. In comparing 402 the incoming sensor data 401 with the predetermined baseline measurement 403, the component may be monitored for any potential anomalies, which may be indicative of a security risk.

The method of FIG. 4 also includes flagging 404, based on detecting that the sensor data differs from the baseline measurement by a threshold amount, the sensor data as indicating a potential security risk. Flagging 404 the sensor data as indicating a potential security risk may be carried out by the monitoring system 106 based on the comparing, and only when the incoming sensor data 401 differs from the predetermined baseline measurement 403 by a threshold amount. The threshold amount is predetermined and may be based on one or more of the component, the type of component, the type of sensor, the present conditions of the component or system, the time of day, the location of the system or component, the function being carried out by the system or component, a workload being executed by the system or component, and the like. The threshold amount may be set to allow for small fluctuations in sensor measurements, such as noise or small differences in conditions or functions from the established baselines. For example, the baseline measurement 403 comes from an established baseline that most closely relates to the system function and conditions that are present within the system being monitored. The selection of such an established baseline may be carried out automatically, such as by either the system being monitored or by the monitoring system 106. In selecting one of multiple available baselines for comparing to incoming sensor data, the established baseline that most closely matches the conditions and functions of the system being monitored is selected to make any potential detections of anomalies as accurate as possible given the available established baselines. Accordingly, allowing for a threshold amount of differences between the incoming sensor data and the baseline measurements may prevent false alarms when detecting anomalies or other potential security risks.

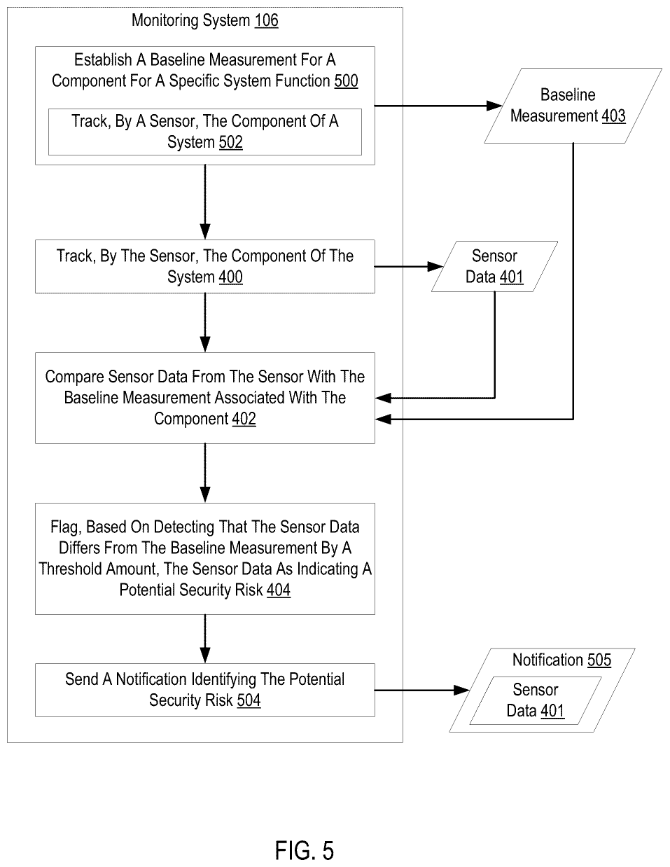

For further explanation, FIG. 5 sets forth a flow chart illustrating an exemplary method of using sensors to detect potential security risks according to embodiments of the present disclosure. The method of FIG. 5 differs from the method of FIG. 4 in that the method of FIG. 5 further includes establishing 500 a baseline for a component for a specific system function. Establishing 500 a baseline for a component for a specific system function may be carried out by the monitoring system 106 and may include tracking 502, by a sensor, the component of the system while the system is carrying out the specific system function. A baseline records measurements of a system or component while the system is functioning normally, taking into account the system functions and any conditions potentially affecting the system. Accordingly, established baselines provide expected measurements for a sensor that continues to monitor the system (or a component of the system), allowing for the detection of system or component anomalies by comparing real-time sensor data with the established baseline. A baseline may be established for many different system functions, as well as within many different conditions. When the monitoring of the system continues, a baseline to be used for comparing is selected (not shown in FIG. 5) based on the current conditions and system functions of the system or component being monitored. An established baseline includes multiple baseline measurements (such as baseline measurement 403).

The example of FIG. 5 shows the baseline being established by monitoring system 106. In another embodiment the baseline may be established by the system being monitored and may be provided to, or retrieved by, the monitoring system 106. In such an embodiment, the baseline is established by sensors within the system being monitored rather than by a sensor associated with the monitoring system. In another embodiment, establishing baselines may be carried out using an AI (artificial intelligence) system to analyze all parts of the system or component functioning as a whole with all of the sensor data from each of multiple sensors to find typical patterns or baselines and to detect anomalies that are above a threshold difference from such baselines.

The method of FIG. 5 also includes sending 504 a notification identifying the potential security risk. Sending 504 a notification identifying the potential security risk may be carried out by monitoring system 106 sending a notification 505 over a network to another computing system, such as an administrator computing system. The notification may be sent over any type of communication platform, such as email, text messaging, proprietary software, and the like. The notification may include an indication of the potential security risk, the particular system being monitored, location information of the system or component, the component being monitored that is associated with the detected anomaly or potential security risk, a copy of the sensor data 401 obtained by the added sensor that provided the detection, and the like. Responsive to flagging the potential security risk, the monitoring system 106 may carry out additional actions. For example, the monitoring system may store the sensor data within memory of the monitoring system, or the system being monitored. In another example, the monitoring system may carry out corrective actions, such as shutting down the component or system, modifying system settings or component settings, changing the function of the system, creating an alarm, contacting personnel, and the like.

In view of the explanations set forth above, readers will recognize that the benefits of using sensors to detect potential security risks according to embodiments of the present disclosure include:
Providing additional security and monitoring for SCADA systems that are not accessible or able to provide trustworthy monitoring capabilities.
Increasing SCADA system reliability by preventing unknown security breaches.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for using sensors to detect potential security risks, comprising:
tracking, by a sensor, a component of a system;
comparing sensor data from the sensor with a baseline measurement associated with the component; and
flagging, based on detecting that the sensor data differs from the baseline measurement by a threshold amount, the sensor data as indicating a potential security risk.

2. The method of claim 1, wherein the baseline measurement is established based on previously tracking the component with the sensor.

3. The method of claim 1, further comprising establishing one or more baselines for the component corresponding, respectively, with one or more system functions.

4. The method of claim 3, wherein a baseline of the one or more baselines is based on a workload being executed by the system.

5. The method of claim 3, wherein the one or more baselines are established using an AI (artificial intelligence) system.

6. The method of claim 1, wherein flagging the sensor data as indicating the potential security risk includes storing the sensor data in memory along with an indication that the sensor data may be associated with the potential security risk.

7. The method of claim 1, further comprising sending a notification identifying the potential security risk, wherein the notification includes the sensor data.

8. The method of claim 1, wherein the threshold amount is based on the component of the system.

9. The method of claim 1, wherein the sensor is tracking a temperature of the component.

10. The method of claim 1, wherein the component is configured to provide supervisory control and data acquisition (SCADA) data.

11. The method of claim 1, wherein the component is an internet of things (IoT) device.

12. A system for using sensors to detect potential security risks, comprising:
a sensor configured to monitor a component of a system; and
a processor communicatively coupled to the sensor and configured to:
track, via the sensor, the component of the system;
compare sensor data from the sensor with a baseline measurement associated with the component; and
flag, based on detecting that the sensor data differs from the baseline measurement by a threshold amount, the sensor data as indicating a potential security risk.

13. The system of claim 12, wherein the baseline measurement is established based on previously tracking the component with the sensor.

14. The system of claim 12, wherein the processor is further configured to establish one or more baselines for the component corresponding, respectively, with one or more system functions.

15. The system of claim 12, wherein flagging the sensor data as indicating the potential security risk includes storing the sensor data in memory along with an indication that the sensor data may be associated with the potential security risk.

16. The system of claim 12, wherein the sensor is configured to monitor multiple components of the system.

17. The system of claim 12, wherein the threshold amount is based on the component of the system.

18. The system of claim 12, wherein the sensor is configured to monitor a temperature of the component.

19. The system of claim 12, wherein the component is configured to provide supervisory control and data acquisition (SCADA) data.

20. The system of claim 12, wherein the component is an internet of things (IoT) device, and wherein the system is a SCADA system.
